(19) United States
(12) Patent Application Publication
(10) Pub. No.: US 2014/0010209 A1
(43) Pub. Date: Jan. 9, 2014

(54) METHODS AND APPARATUSES FOR FACILITATING QUALITY OF SERVICE CONTROL

(71) Applicants: Sami-Jukka Hakola, Kempele (FI); Timo Koskela, Oulu (FI); Vinh Van Phan, Oulu (FI)

(72) Inventors: Sami-Jukka Hakola, Kempele (FI); Timo Koskela, Oulu (FI); Vinh Van Phan, Oulu (FI)

(73) Assignee: NOKIA CORPORATION, Espoo (FI)

(21) Appl. No.: 13/819,612

(22) PCT Filed: Aug. 24, 2011
(86) PCT No.: PCT/FI2011/050737

§ 371 Date: Sep. 18, 2013

Related U.S. Application Data
(60) Provisional application No. 61/377,680, filed on Aug. 27, 2010.

(51) Int. Cl. H04W 76/02

(52) U.S. Cl. CPC H04W 76/023
USPC 370/336; 370/329

(57) ABSTRACT

Methods and apparatuses are provided for facilitating quality of service control. A method may include receiving, at a terminal apparatus, a set of one or more quality of service parameters provisioned by a serving network apparatus. The method may further include determining a configuration setting for controlling quality of service for a device-to-device connection between the terminal apparatus and another device based at least in part on at least one received quality of service parameter. The method may additionally include causing implementation of the determined configuration setting. Corresponding apparatuses are also provided.

### TECHNOLOGICAL FIELD

Example embodiments of the present invention relate generally to communications technology and, more particularly, relate to methods and apparatuses for facilitating quality of service control.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer and providing convenience to users. However, as the number of wireless communication device users continues to increase, the strain on the limited resources in the licensed spectrum also increases.

To provide increased numbers of services to large numbers of users, efficient use of the available radio network resources has become an important consideration. Accordingly, the integration of new network topologies into cellular networks has become an interesting topic to industry planners. In this regard, the study of heterogeneous networks (e.g., networks that employ multiple different access mechanisms such as macro base stations, micro base stations, pico base stations, femto base stations, relays and other devices that may employ the same spectrum, such as within a long term evolution (LTE) or LTE-Advanced (LTE-A) network) has become an important topic in relation to enabling heterogeneous local communication directly between devices and/or machines under the supervision of the network.

One ongoing area of development in heterogeneous local communication technology is the development of device-to-device (D2D) communication technologies. D2D communication technologies may use radio resources of a hosting cellular system, but allow two computing devices, such as mobile terminals (also referred to as user equipment (UE)), to communicate directly with each other without routing their communications through components of the cellular system. Thus, the direct communication link between mobile terminals engaged in D2D communication may result in reduced end-to-end delay time for data exchanged between the terminals as compared to indirect communication via cellular system components. D2D communication may accordingly provide support for use of peer-to-peer applications, head-to-head gaming applications, collaboration, and/or the like by users of mobile terminals within close proximity of each other.

### BRIEF SUMMARY

Methods, apparatuses, and computer program products are herein provided for facilitating quality of service control. Systems, methods, apparatuses, and computer program products in accordance with various embodiments may provide several advantages to computing devices, computing device users, and network providers. Some example embodiments advantageously enable devices engaged in communication over a D2D connection to flexibly and at least semi-autonomously manage and configure the D2D connection. In this regard, in accordance with some example embodiments, rather than being explicitly configured by a serving network with substantial bearer configuration parameters for a D2D connection, devices communicating over a D2D connection may autonomously derive and adjust necessary bearer configurations and operating modes for their D2D connection and service. In this regard, in some example embodiments, an entity of a serving network may provide a terminal apparatus with a set of target quality of service (QoS) parameters for use with a D2D connection. In such example embodiments, the terminal apparatus may utilize the provided QoS parameters as a basis to at least semi-autonomously configure and/or adjust parameters of the D2D connection. Accordingly, some example embodiments may reduce signaling overhead and reduce the burden on a serving network entity by enabling a terminal apparatus engaged in communication over a D2D connection to at least semi-autonomously configure the D2D connection based on a set of guideline QoS parameters provided by the serving network entity in view of real time connection conditions. As such, some example embodiments may both improve QoS in D2D connections and reduce burden on a serving network by reducing signaling overhead.

In an example embodiment, a method is provided, which comprises receiving, at a terminal apparatus, a set of one or more quality of service parameters provisioned by a serving network apparatus. The method of this example embodiment further comprises determining a configuration setting for controlling quality of service for a device-to-device connection between the terminal apparatus and another device based at least in part on at least one received quality of service parameter. The method of this example embodiment may further comprise causing implementation of the determined configuration setting.

In another example embodiment, an apparatus comprising at least one processor and at least one memory storing computer program code is provided. The at least one memory and stored computer program code are configured, with the at least one processor, to cause the apparatus of this example embodiment to at least receive a set of one or more quality of service parameters provisioned by a serving network apparatus. The at least one memory and stored computer program code are configured, with the at least one processor, to further cause the apparatus of this example embodiment to determine a configuration setting for controlling quality of service for a device-to-device connection between the apparatus and another device based at least in part on at least one received quality of service parameter. The at least one memory and stored computer program code may be configured, with the at least one processor, to additionally cause the apparatus of this example embodiment to cause implementation of the determined configuration setting.

In another example embodiment, a computer program product is provided. The computer program product of this example embodiment includes at least one computer-readable storage medium having computer-readable program instructions stored therein. The program instructions of this example embodiment comprise program instructions configured to cause receipt, at a terminal apparatus, a set of one or more quality of service parameters provisioned by a serving network apparatus. The program instructions of this example embodiment further comprise program instructions configured to determine a configuration setting for controlling quality of service for a device-to-device connection between the terminal apparatus and another device based at least in part on at least one received quality of service parameter. The program instructions of this example embodiment may further comprise program instructions configured to cause implementation of the determined configuration setting.

In another example embodiment, an apparatus is provided, which comprises means for receiving a set of one or more quality of service parameters provisioned by a serving network apparatus. The apparatus of this example embodiment further comprises means for determining a configuration setting for controlling quality of service for a device-to-device connection between the apparatus and another device based at least in part on at least one received quality of service parameter. The apparatus of this example embodiment may further comprise means for causing implementation of the determined configuration setting.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a system for facilitating quality of service control according to some example embodiments;

FIG. 2 is a schematic block diagram of a mobile terminal according to some example embodiments;

FIG. 3 illustrates a block diagram of a terminal apparatus according to some example embodiments;

FIG. 4 illustrates a block diagram of a serving network apparatus according to some example embodiments;

FIG. 5 illustrates a method for autonomously controlling quality of service in a device-to-device connection according to some example embodiments;

FIG. 6 illustrates multi-level quality of service control according to some example embodiments;

FIG. 7 illustrates adjustment of an operating mode according to some example embodiments;

FIG. 8 illustrates a flowchart according to an example method for facilitating quality of service control according to some example embodiments; and

FIG. 9 illustrates a flowchart according to an example method for facilitating quality of service control according to some example embodiments.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like.

The term “computer-readable medium” as used herein refers to any medium configured to participate in providing information to a processor, including instructions for execution. Such a medium may take many forms, including, but not limited to a non-transitory computer-readable storage medium (for example, non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a floppy disk, a flexible disk, hard disk, magnetic tape, any other non-transitory magnetic medium, a compact disc read only memory (CD-ROM), compact disc compact disc-rewritable (CD-RW), digital versatile disc (DVD), Blu-Ray, any other non-transitory optical medium, a random access memory (RAM), a programmable read only memory (PROM), an erasable programmable read only memory (EPROM), a FLASH-EPROM, any other non-transitory memory chip or cartridge, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

In D2D communication that is integrated into a cellular network one of the main problems is the dynamic interference fluctuation with relatively large standard deviation at a D2D receiver when compared to the standard deviation of the interference power at a network access point, such as an evolved Node B (eNB). The interference in a normal cellular network (micro/macro network) experienced at the D2D receiver may originate from cellular users in neighboring cells. Additionally, the deviation of the interference may increase as a function of distance to the access point.

Various example embodiments provided herein facilitate quality of service control and may mitigate the effect of interference in D2D communications. Some example embodiments disclosed herein facilitate quality of service control in D2D connections by enabling a terminal apparatus engaged in communication over a D2D connection to at least semi-autonomously determine and implement quality of service control measures without requiring additional signaling to a serving network apparatus. Accordingly, due to a relatively insignificant signaling overhead provided due to the semi-autonomous quality of service control performed by a terminal apparatus, implementation of some example embodiments may have relatively minimal impact on a serving network, such as a serving cellular network.

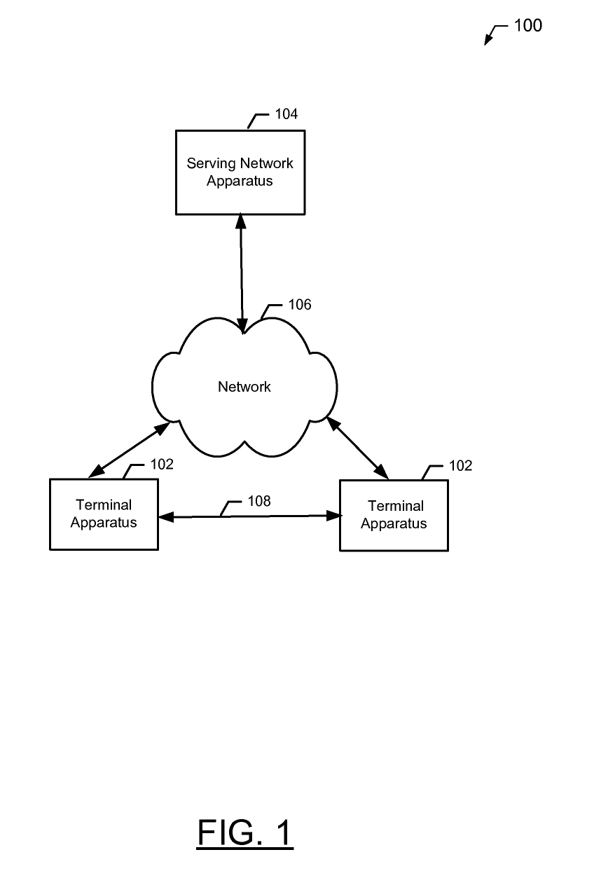

Referring now to FIG. 1, FIG. 1 illustrates a block diagram of a system 100 for facilitating quality of service control according to some example embodiments. It will be appreciated that the system 100 as well as the illustrations in other figures are each provided as an example of some embodiments and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for facilitating quality of service control, numerous other configurations may also be used to implement embodiments of the present invention.

The system 100 may include a plurality of terminal apparatuses 102 and a serving network apparatus 104. The system 100 may further comprise a network 106. The network 106 may comprise one or more wireline networks, one or more wireless networks, or some combination thereof. The network 106 may, for example, comprise a serving network (e.g., a serving cellular network) for one or more terminal apparatuses 102. In some embodiments, the network 106 comprises a public land mobile network (for example, a cellular network), such as may be implemented by a network operator (for example, a cellular access provider). The network 106 may operate in accordance with universal terrestrial radio access network (UTRAN) standards, evolved UTRAN (E-UTRAN) standards, current and future implementations of Third Generation Partnership Project (3GPP) Long Term Evolution (LTE) (also referred to as LTE-A) standards, current and future implementations of International Telecommunications Union (ITU) International Mobile Telecommunications-Advanced (IMT-A) systems standards, and/or the like. It will be appreciated, however, that where references herein are made to a network standard and/or terminology particular to a network standard, the references are provided merely by way of example and not by way of limitation.

One or more of the terminal apparatuses 102 may be configured to communicate with the serving network apparatus 104 over the network 106. In this regard, the serving network apparatus 104 may comprise one or more nodes of the network 106. For example, in some example embodiments, the serving network apparatus 104 may be at least partially embodied on one or more computing devices that comprise an element of a radio access network (RAN) portion of the network 106. In this regard, the serving network apparatus 104 may, for example, be at least partially embodied on an access point of the network 106 (for example, a base station, base transceiver station (BTS), node B, evolved node B, and/or the like), which may, for example be configured to provide access to the network 106 (e.g., via a radio uplink) to one or more of the terminal apparatuses 102. Additionally or alternatively, the serving network apparatus 104 may comprise one or more dedicated computing devices that comprise a portion of a RAN portion of the network 106. In some example embodiments, the serving network apparatus 104 may be at least partially embodied on one or more computing devices that comprise a core network (CN) entity of the network 106. In this regard, the serving network apparatus 104 may, for example, be at least partially embodied on a mobility management entity (MME) of the core network. Additionally or alternatively, the serving network apparatus 104 may comprise one or more dedicated computing devices that comprise a portion of a CN portion of the network 106. As a further example, in the serving network apparatus 104 may comprise a device-to-device registration server function (DRSF). Accordingly, the serving network apparatus 104 may comprise a network node or a plurality of network nodes collectively configured to perform one or more operations attributed to the serving network apparatus 104 as described with respect to various example embodiments disclosed herein.

A terminal apparatus 102 may be configured to establish a D2D connection with another device, such as, another terminal apparatus 102, and engage in D2D communication over the D2D connection. In this regard, two terminal apparatuses are illustrated as communicating via a D2D connection 108 for purposes of example in FIG. 1. The D2D connection may, for example, comprise a direct radio link between two or more apparatuses (e.g., terminal apparatuses 102) and may enable direct inter-device communication without routing communications via one or more elements of the network 106. In some embodiments, a terminal apparatus 102 may be configured with cognitive radio (CR) capabilities such that a terminal apparatus 102 may be configured to sense another device within a proximate range and detect whether a sensed device is configured for device-to-device (D2D) communication.

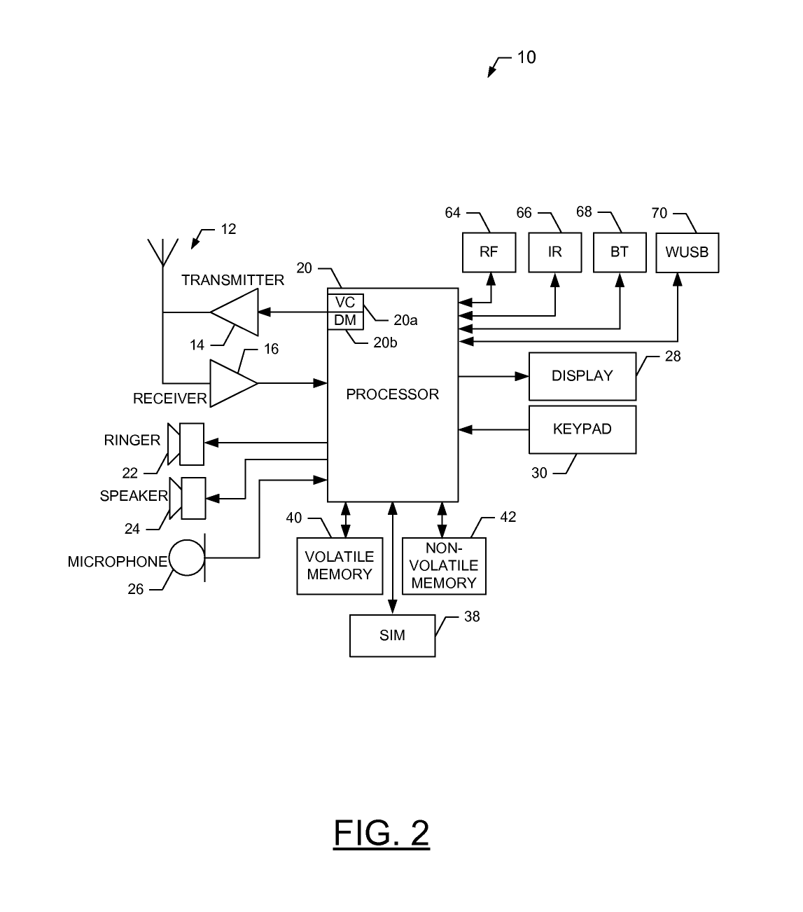

A terminal apparatus 102 may be embodied as any computing device, such as, for example, a desktop computer, laptop computer, mobile terminal, mobile computer, mobile phone, mobile communication device, game device, digital camera/camcorder, audio/video player, television device, radio receiver, digital video recorder, positioning device, wrist watch, portable digital assistant (PDA), any combination thereof, and/or the like. In an example embodiment, a terminal apparatus 102 may be embodied as a mobile terminal, such as that illustrated in FIG. 2

In this regard, FIG. 2 illustrates a block diagram of a mobile terminal 10 representative of some example embodiments of a terminal apparatus 102. It should be understood, however, that the mobile terminal 10 illustrated and hereinafter described is merely illustrative of one type of terminal apparatus 102 that may implement and/or benefit from various embodiments and, therefore, should not be taken to limit the scope of the disclosure. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (for example, session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (for example, digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (for example, software and/or firmware) stored on a memory accessible to the processor 20 (for example, volatile memory 40, non-volatile memory 42, and/or the like). Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (for example, Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wi-Fi, WLAN techniques such as IEEE 802.11 techniques, IEEE 802.15 techniques, IEEE 802.16 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (for example, hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

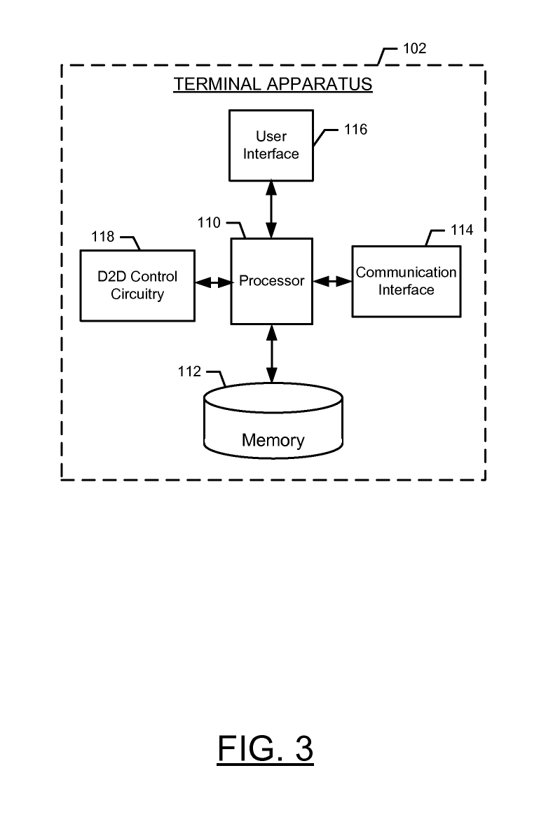

Referring now to FIG. 3, FIG. 3 illustrates a block diagram of a terminal apparatus 102 according to some example embodiments. The terminal apparatus 102 may include various means for performing the various functions herein described. These means may comprise one or more of a processor 110, memory 112, communication interface 114, user interface 116, or device-to-device (D2D) control circuitry 118. The means of the terminal apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (for example memory 112) that is executable by a suitably configured processing device (e.g., the processor 110), or some combination thereof.

In some example embodiments, one or more of the means illustrated in FIG. 3 may be embodied as a chip or chip set. In other words, the terminal apparatus 102 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. In this regard, the processor 110, memory 112, communication interface 114, user interface 116, and/or D2D control circuitry 118 may be embodied as a chip or chip set. The terminal apparatus 102 may therefore, in some example embodiments, be configured to implement embodiments of the present invention on a single chip or as a single “system on a chip.” As another example, in some example embodiments, the terminal apparatus 102 may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 3 as a single processor, in some embodiments the processor 110 comprises a plurality of processors. The plurality of processors may be in operative communication with each other and may be collectively configured to perform one or more functionalities of the terminal apparatus 102 as described herein. The plurality of processors may be embodied on a single computing device or distributed across a plurality of computing devices collectively configured to function as the terminal apparatus 102. In embodiments wherein the terminal apparatus 102 is embodied as a mobile terminal 10, the processor 110 may be embodied as or comprise the processor 20. In some example embodiments, the processor 110 is configured to execute instructions stored in the memory 112 or otherwise accessible to the processor 110. These instructions, when executed by the processor 110, may cause the terminal apparatus 102 to perform one or more of the functionalities of the terminal apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 3 as a single memory, the memory 112 may comprise a plurality of memories. The plurality of memories may be embodied on a single computing device or may be distributed across a plurality of computing devices collectively configured to function as the terminal apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the terminal apparatus 102 is embodied as a mobile terminal 10, the memory 112 may comprise the volatile memory 40 and/or the non-volatile memory 42. The memory 112 may be configured to store information, data, applications, instructions, or the like for enabling the terminal apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. This stored information may be stored and/or used by the D2D control circuitry 118 during the course of performing its functionalities.

The communication interface 114 may be embodied as any device or means embodied in circuitry, hardware, a computer program product comprising computer readable program instructions stored on a computer readable medium (for example, the memory 112) and executed by a processing device (for example, the processor 110), or a combination thereof that is configured to receive and/or transmit data from/to another computing device. In some example embodiments, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the terminal apparatus 102 and one or more computing devices or computing resources may be in communication. As an example, the communication interface 114 may be configured to enable communication between the terminal apparatus 102 and another device, such as another terminal apparatus 102 over a D2D connection, such as the D2D connection 108. As a further example, the communication interface 114 may be configured to enable communication with the serving network apparatus 104 via the network 106. The communication interface 114 may additionally be in communication with the memory 112, user interface 116, and/or D2D control circuitry 118, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. In embodiments wherein the user interface 116 comprises a touch screen display, the user interface 116 may additionally be configured to detect and/or receive indication of a touch gesture or other input to the touch screen display. The user interface 116 may be in communication with the memory 112, communication interface 114, and/or D2D control circuitry 118, such as via a bus.

The D2D control circuitry 118 may be embodied as various means, such as circuitry, hardware, a computer program product comprising computer readable program instructions stored on a computer readable medium (for example, the memory 112) and executed by a processing device (for example, the processor 110), or some combination thereof and, in some embodiments, is embodied as or otherwise controlled by the processor 110. In embodiments wherein the D2D control circuitry 118 is embodied separately from the processor 110, the D2D control circuitry 118 may be in communication with the processor 110. The D2D control circuitry 118 may further be in communication with one or more of the memory 112, communication interface 114, or user interface 116, such as via a bus.

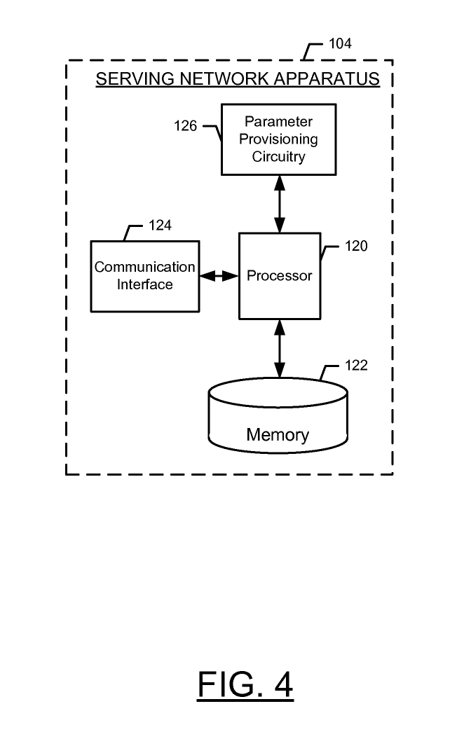

FIG. 4 illustrates a block diagram of a serving network apparatus 104 according to some example embodiments. The serving network apparatus 104 may include various means for performing the various functions herein described. These means may comprise one or more of a processor 120, memory 122, communication interface 124, or parameter provisioning circuitry 126. The means of the serving network apparatus 104 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g., memory 122) that is executable by a suitably configured processing device (e.g., the processor 120), or some combination thereof.

In some example embodiments, one or more of the means illustrated in FIG. 4 may be embodied as a chip or chip set. In other words, the serving network apparatus 104 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. In this regard, the processor 120, memory 122, communication interface 124, and/or parameter provisioning circuitry 126 may be embodied as a chip or chip set. The serving network apparatus 104 may therefore, in some example embodiments, be configured to implement embodiments of the present invention on a single chip or as a single “system on a chip.” As another example, in some example embodiments, the serving network apparatus 104 may comprise component(s) configured to implement embodiments of the present invention on a single chip or as a single “system on a chip.” As such, in some cases, a chip or chipset may constitute means for performing one or more operations for providing the functionalities described herein.

The processor 120 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 4 as a single processor, in some example embodiments the processor 120 comprises a plurality of processors. The plurality of processors may be in operative communication with each other and may be collectively configured to perform one or more functionalities of the serving network apparatus 104 as described herein. The plurality of processors may be embodied on a single computing device or distributed across a plurality of computing devices collectively configured to function as the serving network apparatus 104. In some example embodiments, the processor 120 is configured to execute instructions stored in the memory 122 or otherwise accessible to the processor 120. These instructions, when executed by the processor 120, may cause the serving network apparatus 104 to perform one or more of the functionalities of the serving network apparatus 104 as described herein. As such, whether configured by hardware or software methods, or by a combination thereof, the processor 120 may comprise an entity capable of performing operations according to embodiments of the present invention while configured accordingly. Thus, for example, when the processor 120 is embodied as an ASIC, FPGA or the like, the processor 120 may comprise specifically configured hardware for conducting one or more operations described herein. Alternatively, as another example, when the processor 120 is embodied as an executor of instructions, such as may be stored in the memory 122, the instructions may specifically configure the processor 120 to perform one or more algorithms and operations described herein.

The memory 122 may comprise, for example, volatile memory, non-volatile memory, or some combination thereof. In this regard, the memory 122 may comprise a non-transitory computer-readable storage medium. Although illustrated in FIG. 4 as a single memory, the memory 122 may comprise a plurality of memories. The plurality of memories may be embodied on a single computing device or may be distributed across a plurality of computing devices collectively configured to function as the serving network apparatus 104. In various example embodiments, the memory 122 may comprise a hard disk, random access memory, cache memory, flash memory, a compact disc read only memory (CD-ROM), digital versatile disc read only memory (DVD-ROM), an optical disc, circuitry configured to store information, or some combination thereof. The memory 122 may be configured to store information, data, applications, instructions, or the like for enabling the serving network apparatus 104 to carry out various functions in accordance with various example embodiments. For example, in some example embodiments, the memory 122 is configured to buffer input data for processing by the processor 120. Additionally or alternatively, the memory 122 may be configured to store program instructions for execution by the processor 120. The memory 122 may store information in the form of static and/or dynamic information. This stored information may be stored and/or used by the parameter provisioning circuitry 126 during the course of performing its functionalities.

The communication interface 124 may be embodied as any device or means embodied in circuitry, hardware, a computer program product comprising computer readable program instructions stored on a computer readable medium (for example, the memory 122) and executed by a processing device (for example, the processor 120), or a combination thereof that is configured to receive and/or transmit data from/to another computing device. In some example embodiments, the communication interface 124 is at least partially embodied as or otherwise controlled by the processor 120. In this regard, the communication interface 124 may be in communication with the processor 120, such as via a bus. The communication interface 124 may include, for example, an antenna, a transmitter, a receiver, a transceiver and/or supporting hardware or software for enabling communications with one or more remote computing devices. The communication interface 124 may be configured to receive and/or transmit data using any protocol that may be used for communications between computing devices. In this regard, the communication interface 124 may be configured to receive and/or transmit data using any protocol that may be used for transmission of data over a wireless network, wireline network, some combination thereof, or the like by which the serving network apparatus 104 and one or more computing devices or computing resources may be in communication. As an example, the communication interface 124 may be configured to enable communication with a terminal apparatus 102 by the network 106, a radio uplink, and/or the like. The communication interface 124 may additionally be in communication with the memory 122, and/or parameter provisioning circuitry 126, such as via a bus.

The parameter provisioning circuitry 126 may be embodied as various means, such as circuitry, hardware, a computer program product comprising computer readable program instructions stored on a computer readable medium (for example, the memory 122) and executed by a processing device (for example, the processor 120), or some combination thereof and, in some embodiments, is embodied as or otherwise controlled by the processor 120. In embodiments wherein the parameter provisioning circuitry 126 is embodied separately from the processor 120, the parameter provisioning circuitry 126 may be in communication with the processor 120. The parameter provisioning circuitry 126 may further be in communication with one or more of the memory 122 or communication interface 124, such as via a bus.

In some example embodiments, the parameter provisioning circuitry 126 is configured to provision a terminal apparatus 102 with one or more quality of service parameters that may be used in an existing or future D2D connection between the terminal apparatus 102 and another device. The one or more quality of service parameters may, for example, comprise a recommended or target quality of service value, an allowed fluctuation in quality of service (e.g., minimum and maximum values), and/or the like. For example, the one or more provisioned quality of service parameters may include recommended data throughput and possible fluctuation thereof (or, e.g., minimum and maximum data rates); target effective bit rate and allowed fluctuation thereof (e.g., minimum and/or maximum effective bit rates); maximum packet delay or delay variation; retention priority, and/or the like. The parameter provisioning circuitry 126 may, for example, be configured to provision quality of service parameters to a terminal apparatus 102 based at least in part on conditions of the network 106, such as, traffic load conditions, a detected and/or expected level of interference, previously allocated resources, resources available for allocation, some combination thereof, and/or the like. As a further example, the parameter provisioning circuitry 126 may be additionally or alternatively configured to provision quality of service parameters to a terminal apparatus 102 based at least in part on a relative fairness policy to attempt to ensure relative fairness between users using the network 106 for standard access (e.g., cellular access) and users engaged in network-supported D2D communication. The parameter provisioning circuitry 126 may, for example, be configured to provision the terminal apparatus 102 with the one or more quality of service parameters responsive to a request for establishment of a D2D connection by the terminal apparatus 102, registration of the terminal apparatus 102 with a DRSF, registration/connection of the terminal apparatus 102 to the network 106, an explicit request for quality of service parameters by the terminal apparatus 102, and/or the like.

The parameter provisioning circuitry 126 may be further configured to cause the provisioned quality of service parameters to be sent to the terminal apparatus 102. In this regard, rather than explicitly configuring the terminal apparatus 102 with substantial bearer configuration parameters for a D2D connection, the parameter provisioning circuitry may provision the terminal apparatus 102 with one or more parameters that enable the terminal apparatus 102 to at least semi-autonomously derive configuration settings for use in a D2D connection with another apparatus. In this regard, the terminal apparatus 102 may be enabled to at least semi-autonomously derive and adjust bearer configurations, operating modes, and/or the like for a D2D connection.

The parameter provisioning circuitry 126 may configure and control the one or more quality of service parameters in a semi-static or long-scale fashion. In instances wherein the parameter provisioning circuitry 126 provisions a set of quality of service parameters allowing a relatively high degree of fluctuation in quality of service (for example, a relatively high level of fluctuation in achieved throughput), the terminal apparatus 102 may be enabled to derive D2D bearer configurations and operating modes that may be more relaxed, allowing more tolerance with slower adaptation and simpler operation. In instances wherein the parameter provisioning circuitry 126 provisions a set of quality of service parameters requiring a more absolute quality of service level to be maintained, the terminal apparatus 102 may not be allowed as much control headroom in terms of quality of service fluctuation and the terminal apparatus 102 may derive configuration setting adjustments for D2D bearer configurations, operating modes, and/or the like that are more aggressive to enable link adaptation and operation within the required quality of service level.

The D2D control circuitry 118 may accordingly be configured to receive one or more quality of service parameters provisioned to the terminal apparatus 102 by the serving network apparatus 104. The D2D control circuitry 128 may be further configured to determine a configuration setting for controlling quality of service for a D2D connection between the terminal apparatus 102 and another device based at least in part on at least one received quality of service parameter. In this regard, the D2D control circuitry 128 may be configured to autonomously determine the configuration setting without signaling the serving network apparatus 104. The D2D control circuitry 118 may be further configured to cause implementation of the determined configuration setting.

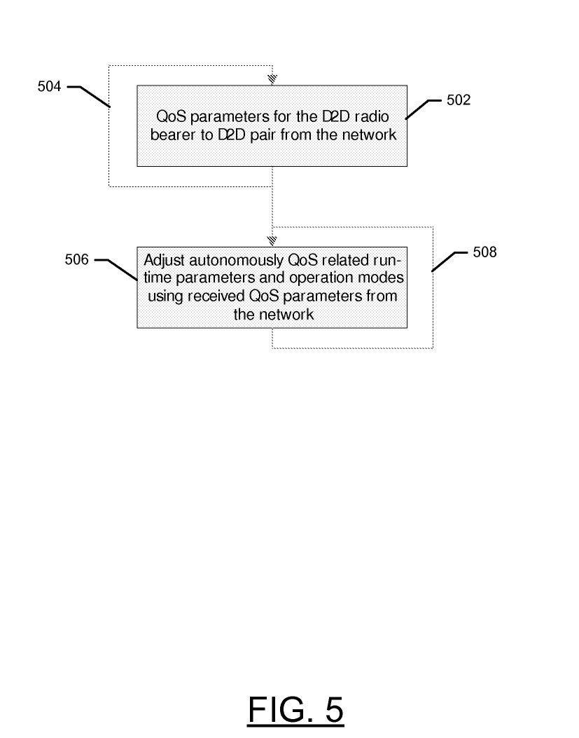

FIG. 5 illustrates a method for autonomously controlling quality of service in a D2D connection according to some example embodiments. Operation 502 may comprise the parameter provisioning circuitry 126 provisioning quality of service parameters for a D2D radio bearer to a pair of terminal apparatuses 102. These parameters may be provisioned on a relatively long term or static basis. However, as illustrated by operation 504, the parameter provisioning circuitry 126 may provision additional and/or replacement quality of service parameters by repeating operation 502. In this regard, operation 504 may, for example, be performed responsive to an explicit request from a terminal apparatus 102. As another example, operation 504 may be performed responsive to changed network conditions, such as changed traffic load conditions, a change in a detected and/or expected level of interference, a change in the balance of allocated resources, a need to free resources such as due to traffic load, some combination thereof, and/or the like.

Operation 506 may comprise the D2D control circuitry 128 autonomously adjusting one or more configuration settings (e.g., quality of service related run-time parameters, operation modes, and/or the like) based at least in part on the received quality of service parameters. As illustrated by operation 508, operation 506 may be repeated, such as responsive to detection by the D2D control circuitry 128 of a quality of service condition between the terminal apparatus 102 and another device. In this regard, the D2D control circuitry 128 may be configured to determine a quality of service condition of the D2D connection. Accordingly, the D2D control circuitry 128 may be configured to determine a configuration setting based at least in part on the determined quality of service condition and one or more provisioned quality of service parameters. For example, if a provisioned quality of service parameter sets forth a target quality of service value, the D2D control circuitry 128 may compare a determined quality of service condition to the target quality of service value and, if necessary, adjust a configuration setting to attempt to adjust the actual quality of service to at least substantially meet the target quality of service value. As another example, if one or more provisioned quality of service parameters defines an allowed quality of service fluctuation and a determined quality of service condition falls outside the bounds of allowable fluctuation, the D2D control circuitry 128 may determine an appropriate adjustment to a configuration setting to bring the quality of service within the bounds of allowable fluctuation. As such, the D2D control circuitry 128 may be configured to autonomously monitor channel conditions and determine adjustments to configuration settings based at least in part on determined quality of service conditions and the provisioned quality of service parameters.

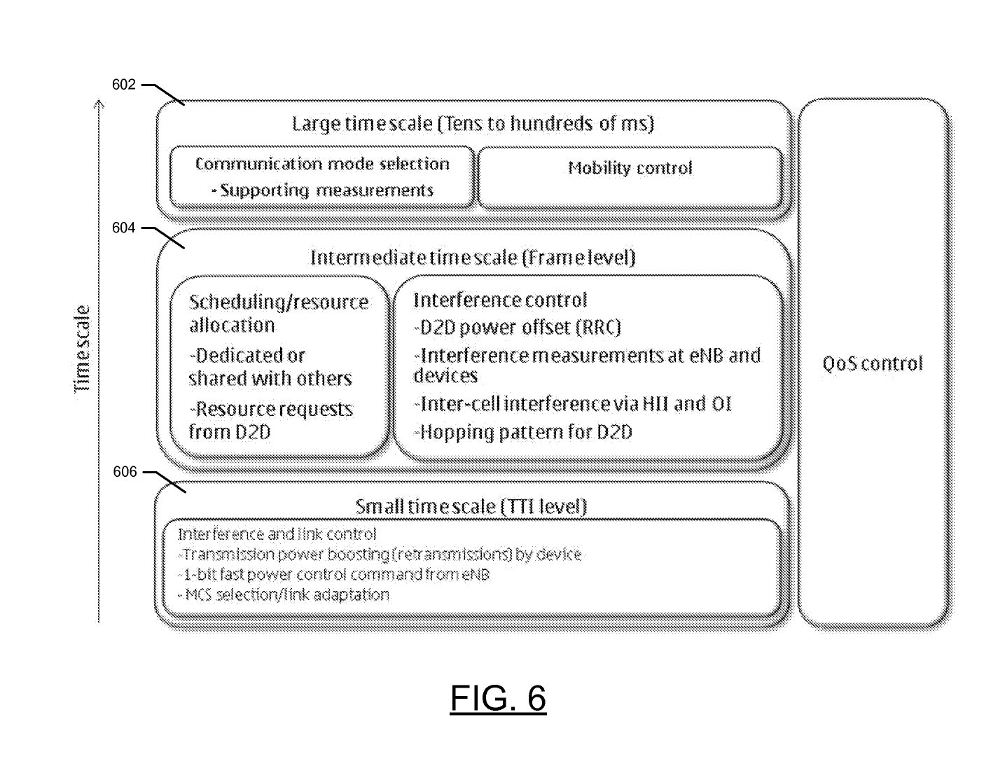

In some example embodiments, the D2D control circuitry 128 may be configured to determine configuration settings at a plurality of levels. In this regard, FIG. 6 illustrates multi-level quality of service control according to some example embodiments. For example, the D2D control circuitry 128 may be configured to determine a quality of service configuration setting at an inter-frame level covering a relatively large time scale of tens to hundreds of milliseconds, which may cover a plurality of frames. For example, the D2D control circuitry 128 may be configured to change an operating mode, such as a radio link control (RLC) operating mode in order to provide quality of service control at an inter-frame level. The D2D control circuitry 128 may be further configured to determine a quality of service configuration setting at a frame level, which may comprise an intermediate time scale. For example, the D2D control circuitry 128 may be configured to determine an adjustment to a power offset, such as a radio resource control (RRC) power offset, an adjustment to a target block error rate (BLER), and/or the like to provide quality of service control at a frame level. The D2D control circuitry 128 may be additionally configured to determine a quality of service configuration setting at a transmission time interval (TTI) level, which may comprise a relatively small time scale. For example, the D2D control circuitry 128 may be configured to determine an adjustment to a transmission power to provide quality of service control at a TTI level.

The set of one or more quality of service parameters may comprise an acceptable error rate and determining a configuration setting may comprise determining an adjustment to transmission power based at least in part on an actual error rate for a transmission in the connection. For example, the terminal apparatus 102 may be engaged in D2D communication over a connection in which hybrid automatic repeat request (HARQ) operation is enabled. There may be a first BLER target value for a first transmission, a second BLER target value for one or more subsequent transmissions, and so on. The D2D control circuitry 118 may be configured to use a closed-loop power control based on, for example, HARQ ACK/NACK and outer-loop power control based on the first and second BLER target values. For an instance in which the terminal apparatus 102 has transmitted data over the D2D connection and a HARQ ACK is received, the D2D control circuitry 118 may adjust a transmission power (Pₐ) by a predefined first step down value. In an instance in which the terminal apparatus 102 has transmitted data over the D2D connection and receives a HARQ NACK or does not receive an acknowledgement, the D2D control circuitry 118 may be configured to adjust the transmission power by a predefined first step up value. The step up and step down values may be larger in an instance in which a quality of service parameter provisioned by the serving network apparatus 104 allows for a relatively small amount of fluctuation in quality of service. Contrastingly, the step up and step down values may be smaller in an instance in which a quality of service parameter provisioned by the serving network apparatus 104 allows for a relatively large amount of fluctuation in quality of service. Subsequent to adjusting the transmission power by the step up value, the D2D control circuitry 118 may be configured to adjust the transmission power by a second step down value (e.g., a step down value smaller than the first step down value) or a second step up value (e.g., a step up value smaller than the first step up value) depending on whether a subsequent transmission is acknowledged or not acknowledged. The logic for a transmitting terminal apparatus 102 may, for example, be implemented as follows:
In response to receiving a HARQ ACK at the first transmission attempt may adjust Ptx by step-down#1
else by step-up#1
   if ACK received at any subsequent attempt step-down#2
   else by step-up#2
      In an instance in which the terminal apparatus 102 is receiving data from another device over a D2D connection, the D2D control circuitry 118 may be configured to adjust transmission power based at least in part on whether the terminal apparatus 102 receives or fails to receive data sent by the other device (e.g., whether the terminal apparatus 102 sends a HARQ ACK or a NACK). In this regard, if the terminal apparatus 102 sends a HARQ ACK, the D2D control circuitry 118 may reduce the transmission power by a step down value. If, however, the terminal apparatus 102 sends a HARQ ACK, the D2D control circuitry 118 may increase the transmission power by a step up value.

The set of quality of service parameters provisioned to the terminal apparatus 102 may comprise a threshold packet error rate and the D2D control circuitry 118 may be configured to determine to change a radio link control operating mode in response to an actual packet error rate in the connection exceeding the threshold. As an example, the D2D control circuitry 118 may be configured to determine to change a radio link control (RLC) operating mode responsive to a determined quality of service condition of the D2D connection. For example, the D2D control circuitry 118 may be configured to select one of RLC acknowledged mode (RLC AM), RLC unacknowledged mode (RLC UM), or RLC transparent mode (RLC TM). In this regard, the D2D control circuitry 118 may be configured to select an RLC operating mode based at least in part on allowed quality of service fluctuation and relatively slow varying channel conditions of the D2D link.

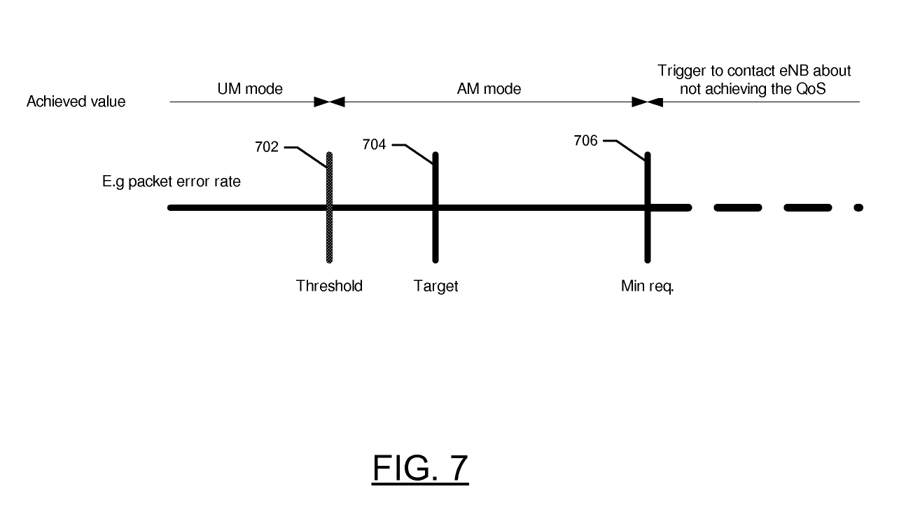

Referring now to FIG. 7, FIG. 7 illustrates adjustment of an operating mode according to some example embodiments. The terminal apparatus 102 may be provisioned with a threshold packet error rate value 702, a target packet error rate value 704, and a minimum required quality of service value 706. As another example, the terminal apparatus 102 and a device with which the terminal apparatus 102 has established a D2D connection may mutually agree (with or without assistance from the serving network apparatus 104) on the threshold packet error rate value 706. RLC TM may be selected for simple D2D operation, relying on possible transport-layer end-to-end retransmission and/or L1-L2 HARQ operation when the D2D channel quality is in a good condition. In an instance in which the D2D control circuitry 118 determines that the actual achieved value of the packet error rate is higher than the threshold packet error rate value 702, the D2D control circuitry 118 may select to use RLC UM. In an instance in which the D2D control circuitry 118 determines that the actual achieved value of the packet error rate is below the threshold packet error rate value 702, the D2D control circuitry 118 may select to use RLC AM. Accordingly, an autonomous adjustment of operating mode may be provided without requiring control by the serving network apparatus 104 into prevailing D2D channel conditions. Further, processing burden may be reduced when there are a tolerable number of packet errors (e.g., less than a threshold number of packet errors) by selecting an operating mode requiring less processing burden. However, control may be increased when there are more packet errors (e.g., more than a threshold number of packet errors) by selecting an operating mode providing more error control. However, in an instance in which packet error rate falls outside the minimum required quality of service value 706, the D2D control circuitry 118 may contact a serving eNB or other serving network apparatus 104 to inform that the required quality of service is not being achieved.

The set of quality of service parameters provisioned to the terminal apparatus 102 may comprise one or more of a target throughput or an allowed fluctuation in throughput and the D2D control circuitry 118 may be configured to determine a power boost value based at least in part on the one or more of the target throughput or the allowed fluctuation in throughput and further based on an actual throughput for the D2D connection. As an example, the actual achieved average metric (e.g., throughput) may be denoted as \hat{r}, the configured target value for the metric as r, and the minimum and maximum values for the metric as, rₘᵢₙ and rₘₐₓ, respectively. Configuration settings may be adjusted to ensure that \hat{r} stays within range defined by rₘᵢₙ and rₘₐₓ. Otherwise, the D2D control circuitry 118 may be configured to request other action be taken, such as re-allocation of radio resources by the serving network apparatus 104. Boosting power as may be determined by the D2D control circuitry 118 may be defined as a function of the target value and the minimum value, e.g.

$${P}_{boost} ∝ ( \frac{r - {r}_{min}}{r} ) \times {P}_{allowed}$$

where P_{allowed} may be configured by the serving network apparatus 104 as a provisioned quality of service parameter. The usage of additional boosting power may be triggered in an instance in which the D2D control circuitry 118 determines the interference level has increased since the first transmission of a specific HARQ process by a predefined amount.

As another example for deriving additional boosting power while trying to guarantee quality of service requirements, the D2D control circuitry 118 may be configured to allow that the more boosting power the higher difference between the target and the achieved average value is. In this regard, the boosting power as may be determined by the D2D control circuitry 118 may be defined by, e.g.,

$${P}_{boost} ∝ ( \frac{max ( 0 , r - \hat{r} )}{r - {r}_{min}} ) \times {P}_{allowed}$$

where \hat{r}>rₘᵢₙ; and the usage of the boosting power may be triggered when the average value \hat{r} is below the target value r.

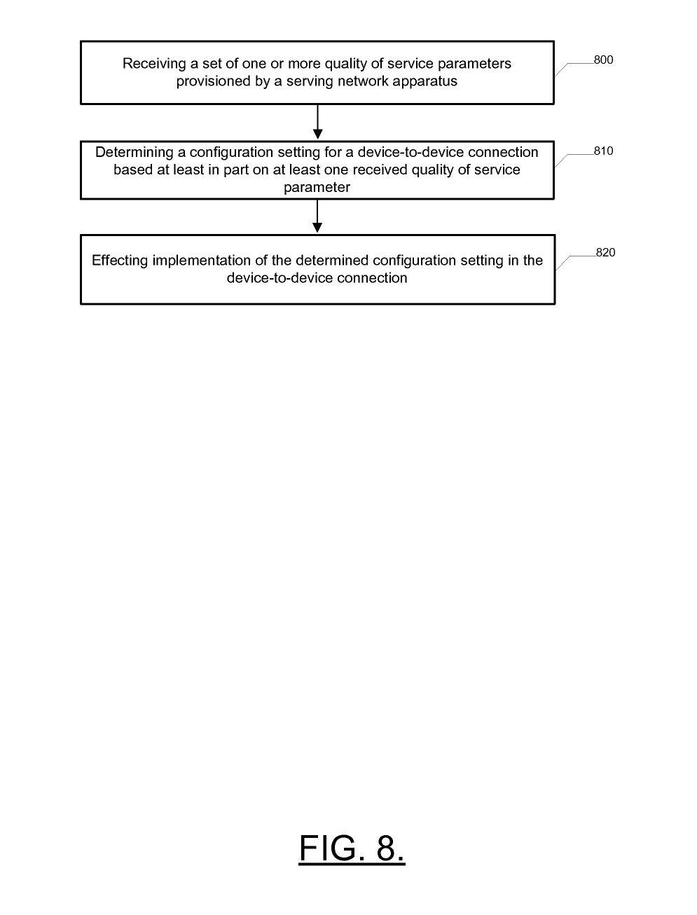

FIG. 8 illustrates a flowchart according to an example method for facilitating quality of service control according to some example embodiments. In this regard, FIG. 8 illustrates operations that may be performed at a terminal apparatus 102. The operations illustrated in and described with respect to FIG. 8 may, for example, be performed by, with the assistance of, and/or under the control of one or more of the processor 110, memory 112, communication interface 114, or D2D control circuitry 118. Operation 800 may comprise receiving a set of one or more quality of service parameter provisioned by a serving network apparatus 104. The processor 110, memory 112, communication interface 114, and/or D2D control circuitry 118 may, for example, provide means for performing operation 800. Operation 810 may comprise determining a configuration setting for a device-to-device connection based at least in part on at least one received quality of service parameter. The processor 110, memory 112, and/or D2D control circuitry 118 may, for example, provide means for performing operation 810. Operation 820 may comprise effecting implementation of the determined configuration setting in the device-to-device connection. The processor 110, memory 112, communication interface 114, and/or D2D control circuitry 118 may, for example, provide means for performing operation 820.

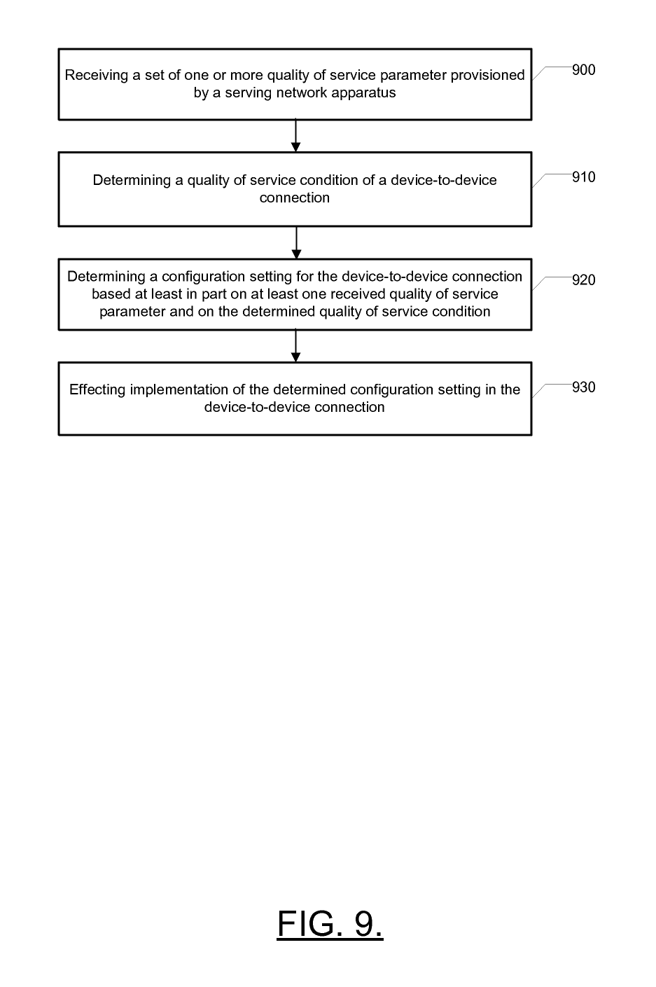

FIG. 9 illustrates a flowchart according to another example method for facilitating quality of service control according to some example embodiments. In this regard, FIG. 9 illustrates operations that may be performed at a terminal apparatus 102. The operations illustrated in and described with respect to FIG. 9 may, for example, be performed by, with the assistance of, and/or under the control of one or more of the processor 110, memory 112, communication interface 114, or D2D control circuitry 118. Operation 900 may comprise receiving a set of one or more quality of service parameters provisioned by a serving network apparatus 104. The processor 110, memory 112, communication interface 114, and/or D2D control circuitry 118 may, for example, provide means for performing operation 900. Operation 910 may comprise determining a quality of service condition of a device-to-device condition. The processor 110, memory 112, communication interface 114, and/or D2D control circuitry 118 may, for example, provide means for performing operation 910. Operation 920 may comprise determining a configuration setting for the device-to-device connection based at least in part on at least one received quality of service parameter and on the determined quality of service condition. The processor 110, memory 112, and/or D2D control circuitry 118 may, for example, provide means for performing operation 920. Operation 930 may comprise effecting implementation of the determined configuration setting in the device-to-device connection. The processor 110, memory 112, communication interface 114, and/or D2D control circuitry 118 may, for example, provide means for performing operation 930.

FIGS. 8-9 each illustrate a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 112) and executed by a processor in the computing device (for example, by the processor 110). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, a terminal apparatus 102) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, a terminal apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out various embodiments. In one embodiment, a suitably configured processor (for example, the processor 110 and/or processor 120) may provide all or a portion of the elements. In another embodiment, all or a portion of the elements may be configured by and operate under control of a computer program product. The computer program product for performing the methods of embodiments of the invention includes a computer-readable storage medium (for example, the memory 112 and/or memory 122), such as the non-volatile storage medium, and computer-readable program code portions, such as a series of computer instructions, embodied in the computer-readable storage medium.

In an example embodiment, a method is provided, which comprises receiving, at a terminal apparatus, a set of one or more quality of service parameters provisioned by a serving network apparatus. The method of this example embodiment further comprises determining a configuration setting for controlling quality of service for a device-to-device connection between the terminal apparatus and another device based at least in part on at least one received quality of service parameter. The method of this example embodiment may further comprise causing implementation of the determined configuration setting.

Determining the configuration setting may comprise determining the configuration setting by a processor. As another example, determining the configuration setting may comprise using device-to-device control circuitry to determine the configuration setting.

Determining the configuration setting may comprise autonomously determining the configuration setting without signaling the serving network apparatus. The one or more quality of service parameters may comprise one or more quality of service parameters defining an allowed quality of service fluctuation. The method may further comprise determining a quality of service condition of the device-to-device connection. Determining the configuration setting may comprise determining the configuration setting based at least in part on the determined quality of service condition and the allowed quality of service fluctuation.

Determining the configuration setting may comprise determining at least one configuration setting for controlling quality of service at each of a plurality of levels. The plurality of levels may comprise two or more of a transmission time interval level, frame level, or inter-frame level. Determining a configuration setting at the transmission time interval level may comprise determining an adjustment to a transmission power level. Determining a configuration setting at the frame level may comprise determining an adjustment to a target block error rate value. Determining a configuration setting at the inter-frame level may comprise determining to switch a radio link control operating mode.

The set of one or more quality of service parameters may comprise an acceptable error rate and determining a configuration setting may comprise determining an adjustment to transmission power based at least in part on an actual error rate for a transmission in the connection. The set of one or more quality of service parameters may comprise a threshold packet error rate and determining a configuration setting may comprise determining to change a radio link control operating mode in response to an actual packet error rate in the connection exceeding the threshold. The set of one or more quality of service parameters may comprise one or more of a target throughput or an allowed fluctuation in throughput and determining a configuration setting may comprise determining a power boost value based at least in part on the one or more of the target throughput or the allowed fluctuation in throughput and further based on an actual throughput for the connection.

In another example embodiment, an apparatus comprising at least one processor and at least one memory storing computer program code is provided. The at least one memory and stored computer program code are configured, with the at least one processor, to cause the apparatus of this example embodiment to at least receive a set of one or more quality of service parameters provisioned by a serving network apparatus. The at least one memory and stored computer program code are configured, with the at least one processor, to further cause the apparatus of this example embodiment to determine a configuration setting for controlling quality of service for a device-to-device connection between the apparatus and another device based at least in part on at least one received quality of service parameter. The at least one memory and stored computer program code may be configured, with the at least one processor, to additionally cause the apparatus of this example embodiment to cause implementation of the determined configuration setting.

The at least one memory and stored computer program code may be configured, with the at least one processor, to cause the apparatus of this example embodiment to determine the configuration setting autonomously without signaling the serving network apparatus. The one or more quality of service parameters may comprise one or more quality of service parameters defining an allowed quality of service fluctuation. The at least one memory and stored computer program code may be configured, with the at least one processor, to additionally cause the apparatus of this example embodiment to determine a quality of service condition of the device-to-device connection. The at least one memory and stored computer program code may be configured, with the at least one processor, to cause the apparatus of this example embodiment to determine the configuration setting by determining the configuration setting based at least in part on the determined quality of service condition and the allowed quality of service fluctuation.

The at least one memory and stored computer program code may be configured, with the at least one processor, to cause the apparatus of this example embodiment to determine the configuration setting by determining at least one configuration setting for controlling quality of service at each of a plurality of levels. The plurality of levels may comprise two or more of a transmission time interval level, frame level, or inter-frame level. The at least one memory and stored computer program code may be configured, with the at least one processor, to cause the apparatus of this example embodiment to determine a configuration setting at the transmission time interval level at least in part by determining an adjustment to a transmission power level. The at least one memory and stored computer program code may be configured, with the at least one processor, to cause the apparatus of this example embodiment to determine a configuration setting at the frame level at least in part by determining an adjustment to a target block error rate value. The at least one memory and stored computer program code may be configured, with the at least one processor, to cause the apparatus of this example embodiment to determine a configuration setting at the inter-frame level at least in part by determining to switch a radio link control operating mode.

The set of one or more quality of service parameters may comprise an acceptable error rate and the at least one memory and stored computer program code may be configured, with the at least one processor, to cause the apparatus of this example embodiment to determine a configuration setting at least in part by determining an adjustment to transmission power based at least in part on an actual error rate for a transmission in the connection. The set of one or more quality of service parameters may comprise a threshold packet error rate and the at least one memory and stored computer program code may be configured, with the at least one processor, to cause the apparatus of this example embodiment to determine a configuration setting at least in part by determining to change a radio link control operating mode in response to an actual packet error rate in the connection exceeding the threshold. The set of one or more quality of service parameters may comprise one or more of a target throughput or an allowed fluctuation in throughput and the at least one memory and stored computer program code may be configured, with the at least one processor, to cause the apparatus of this example embodiment to determine a configuration setting at least in part by determining a power boost value based at least in part on the one or more of the target throughput or the allowed fluctuation in throughput and further based on an actual throughput for the connection.

In another example embodiment, a computer program product is provided. The computer program product of this example embodiment includes at least one computer-readable storage medium having computer-readable program instructions stored therein. The program instructions of this example embodiment comprise program instructions configured to cause receipt, at a terminal apparatus, a set of one or more quality of service parameters provisioned by a serving network apparatus. The program instructions of this example embodiment further comprise program instructions configured to determine a configuration setting for controlling quality of service for a device-to-device connection between the terminal apparatus and another device based at least in part on at least one received quality of service parameter. The program instructions of this example embodiment may further comprise program instructions configured to cause implementation of the determined configuration setting.

The program instructions configured to determine the configuration setting may comprise program instructions configured to autonomously determine the configuration setting without signaling the serving network apparatus. The one or more quality of service parameters may comprise one or more quality of service parameters defining an allowed quality of service fluctuation. The program instructions of this example embodiment may further comprise program instructions configured to determine a quality of service condition of the device-to-device connection. The program instructions configured to determine the configuration setting may comprise program instructions configured to determine the configuration setting based at least in part on the determined quality of service condition and the allowed quality of service fluctuation.

The program instructions configured to determine the configuration setting may comprise program instructions configured to determine at least one configuration setting for controlling quality of service at each of a plurality of levels. The plurality of levels may comprise two or more of a transmission time interval level, frame level, or inter-frame level. The program instructions configured to determine a configuration setting at the transmission time interval level may comprise program instructions configured to determine an adjustment to a transmission power level. The program instructions configured to determine a configuration setting at the frame level may comprise program instructions configured to determine an adjustment to a target block error rate value. The program instructions configured to determine a configuration setting at the inter-frame level may comprise program instructions configured to determine to switch a radio link control operating mode.

The set of one or more quality of service parameters may comprise an acceptable error rate and the program instructions configured to determine a configuration setting may comprise program instructions configured to determine an adjustment to transmission power based at least in part on an actual error rate for a transmission in the connection. The set of one or more quality of service parameters may comprise a threshold packet error rate and the program instructions configured to determine a configuration setting may comprise program instructions configured to determine to change a radio link control operating mode in response to an actual packet error rate in the connection exceeding the threshold. The set of one or more quality of service parameters may comprise one or more of a target throughput or an allowed fluctuation in throughput and the program instructions configured to determine a configuration setting may comprise program instructions configured to determine a power boost value based at least in part on the one or more of the target throughput or the allowed fluctuation in throughput and further based on an actual throughput for the connection.

In another example embodiment, an apparatus is provided, which comprises means for receiving a set of one or more quality of service parameters provisioned by a serving network apparatus. The apparatus of this example embodiment further comprises means for determining a configuration setting for controlling quality of service for a device-to-device connection between the apparatus and another device based at least in part on at least one received quality of service parameter. The apparatus of this example embodiment may further comprise means for causing implementation of the determined configuration setting.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A method comprising:
receiving, at a terminal apparatus, a set of one or more quality of service parameters provisioned by a serving network apparatus; and
determining a configuration setting for controlling quality of service for a device-to-device connection between the terminal apparatus and another device based at least in part on at least one received quality of service parameter.

2-5. (canceled)

6. The method of claim 1, wherein determining the configuration setting comprises determining at least one configuration setting for controlling quality of service at each of a plurality of levels.

7. The method of claim 6, wherein the plurality of levels comprises two or more of a transmission time interval level, a frame level, or an inter-frame level.

8. The method of claim 6, wherein determining at least one configuration setting for controlling quality of service at each of a plurality of levels comprises determining a configuration setting at a transmission time interval level, and wherein determining a configuration setting at the transmission time interval level comprises determining an adjustment to a transmission power level.

9. The method of claim 6, wherein determining at least one configuration setting for controlling quality of service at each of a plurality of levels comprises determining a configuration setting at a frame level, and wherein determining a configuration setting at the frame level comprises determining an adjustment to a target block error rate value.

10. The method of claim 6, wherein determining at least one configuration setting for controlling quality of service at each of a plurality of levels comprises determining a configuration setting at an inter-frame level, and wherein determining a configuration setting at the inter-frame level comprises determining to switch a radio link control operating mode.

11-15. (canceled)

16. An apparatus comprising at least one processor and at least one memory storing computer program code, wherein the at least one memory and stored computer program code are configured, with the at least one processor, to cause the apparatus to at least perform:
receiving, at a terminal apparatus, a set of one or more quality of service parameters provisioned by a serving network apparatus; and
determining a configuration setting for controlling quality of service for a device-to-device connection between the terminal apparatus and another device based at least in part on at least one received quality of service parameter.

17. (canceled)

18. The apparatus of claim 16, wherein determining the configuration setting comprises autonomously determining the configuration setting without signaling the serving network apparatus.

19. The apparatus of claim 16, wherein the at least one memory and stored computer program code are configured, with the at least one processor, to further cause the apparatus to perform determining a quality of service condition of the device-to-device connection, and wherein determining the configuration setting comprises determining the configuration setting based at least in part on the determined quality of service condition.

20. The apparatus of claim 16, wherein the one or more quality of service parameters comprise one or more quality of service parameters defining an allowed quality of service fluctuation, and wherein determining the configuration setting comprises determining the configuration setting further based on a quality of service condition of the device-to-device connection and on the allowed quality of service fluctuation.

21. The apparatus of claim 16, wherein determining the configuration setting comprises determining at least one configuration setting for controlling quality of service at each of a plurality of levels.

22. The apparatus of claim 21, wherein the plurality of levels comprises two or more of a transmission time interval level, a frame level, or an inter-frame level.

23. The apparatus of claim 21, wherein determining at least one configuration setting for controlling quality of service at each of a plurality of levels comprises determining a configuration setting at a transmission time interval level, and wherein determining a configuration setting at the transmission time interval level comprises determining an adjustment to a transmission power level.

24. The apparatus of claim 21, wherein determining at least one configuration setting for controlling quality of service at each of a plurality of levels comprises determining a configuration setting at a frame level, and wherein determining a configuration setting at the frame level comprises determining an adjustment to a target block error rate value.

25. The apparatus of claim 21, wherein determining at least one configuration setting for controlling quality of service at each of a plurality of levels comprises determining a configuration setting at an inter-frame level, and wherein determining a configuration setting at the inter-frame level comprises determining to switch a radio link control operating mode.

26. The apparatus of claim 16, wherein the set of one or more quality of service parameters comprises an acceptable error rate, and wherein determining a configuration setting comprises determining an adjustment to transmission power based at least in part on an actual error rate for a transmission in the connection.

27. The apparatus of claim 16, wherein the set of one or more quality of service parameters comprises a threshold packet error rate, and wherein determining a configuration setting comprises determining to change a radio link control operating mode in response to an actual packet error rate in the connection exceeding the threshold.

28. The apparatus of claim 16, wherein the set of one or more quality of service parameters comprises one or more of a target throughput or an allowed fluctuation in throughput, and wherein determining a configuration setting comprises determining a power boost value based at least in part on the one or more of the target throughput or the allowed fluctuation in throughput and further based on an actual throughput for the connection.

29. The apparatus of claim 16, wherein the apparatus comprises or is embodied on a mobile phone, the mobile phone comprising user interface circuitry and user interface software stored on one or more of the at least one memory; wherein the user interface circuitry and user interface software are configured to:
facilitate user control of at least some functions of the mobile phone through use of a display; and
cause at least a portion of a user interface of the mobile phone to be displayed on the display to facilitate user control of at least some functions of the mobile phone.

30. A computer program product comprising at least one computer-readable storage medium having computer-readable program instructions stored therein, the computer-readable program instructions comprising:
program instructions for receiving, at a terminal apparatus, a set of one or more quality of service parameters provisioned by a serving network apparatus; and
program instructions for determining a configuration setting for controlling quality of service for a device-to-device connection between the terminal apparatus and another device based at least in part on at least one received quality of service parameter.

31-55. (canceled)
